(19) United States
(12) Patent Application Publication
(10) Pub. No.: US 2023/0013529 A1
(43) Pub. Date: Jan. 19, 2023

(54) Gravity Machine

(71) Applicant: Nelda Beatrice Brown, Marlin, TX (US)

(72) Inventor: Gene Brown, Marlin, TX (US)

(21) Appl. No.: 17/953,762

(22) Filed: Sep. 27, 2022

Related U.S. Application Data
(63) Continuation of application No. 17/575,980, filed on Jan. 14, 2022, now abandoned.
(60) Provisional application No. 63/176,453, filed on Apr. 19, 2021.

(51) Int. Cl. F03G 3/00

(52) U.S. Cl. CPC F03G 3/094; F03G 3/091

(57) ABSTRACT

A machine having two interconnected wheels, one having hinged weighted arms that fall with gravity to rotate the wheel and store rotational energy for use in a connected shaft.

### CROSS-REFERENCES TO RELATED APPLICATIONS

This application claims the benefit of U.S. application Ser. No. 17/575,980, filed Jan. 14, 2022, which in turn claims the benefit of a provisional application No. 63/176,453 entitled GRAVITY MACHINE, filed Apr. 19, 2021. The provisional application is incorporated in its entirety by reference.

### FIELD OF INVENTION

The present invention relates generally a machine having two interconnected wheels, one having hinged weighted arms that fall with gravity to rotate the wheel and store and maintain rotational energy for a connected shaft.

### BACKGROUND OF THE INVENTION

It is increasingly desirable to generate electric power without use of fossil fuels. Many alternatives to fossil fuel have been developed, some more useful than others. It is desirable to use and store natural sources of energy, such as wind, tidal, solar and the like.

### SUMMARY OF THE INVENTION

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter. The present invention is defined by the claims.

The present invention uses the gravitational potential energy to store energy in a first wheel with hinged weighted arms to provide rotation energy for a variety of uses. A second wheel, connected to the first returns the first wheel to its original position.

### BRIEF DESCRIPTION OF THE DRAWINGS

The present invention is described in detail below with reference to the attached drawing figures, wherein:

FIG. 1A is a perspective view of one an embodiment of the invention showing elements of the gravity machine structure in one position.

FIG. 1B is a perspective view of one an embodiment of the invention showing elements of the gravity machine structure.

FIG. 1C is a plan view of another embodiment of the invention showing a main frame and hinged weighted arms.

FIG. 2A is a plan view of an embodiment of the invention showing a main or drive wheel of the gravity machine structure with spokes to reduce weight.

FIG. 2B is a plan view of an embodiment of the invention showing a wheel of the gravity machine structure with spokes to reduce weight.

FIG. 3 is a schematic view of an embodiment of the invention showing two machines interconnected.

FIG. 4 is a perspective view of an embodiment of the invention showing a means to reposition the control wheel.

FIG. 5 is a perspective view of an embodiment of the invention showing double weighted arms.

FIG. 6 is a perspective view of an embodiment of the invention showing offset hinged weighted arms.

FIG. 7 is another perspective view of an embodiment of the invention showing offset hinged weighted arms.

### DETAILED DESCRIPTION OF THE INVENTION

Some embodiments of the present invention are described with specificity herein to meet statutory requirements. However, the scope of the invention is not intended to be defined by the description itself. The claimed subject matter may be embodied as to include different features, elements, components, steps, or combinations of steps, similar to those described herein, and in combination with other existing or future technologies. Moreover, although the term “step” might be used to connote different elements of the methods employed, this term should not be interpreted as implying any particular order among or between various steps herein disclosed unless and except the order of individual steps is explicitly described or required.

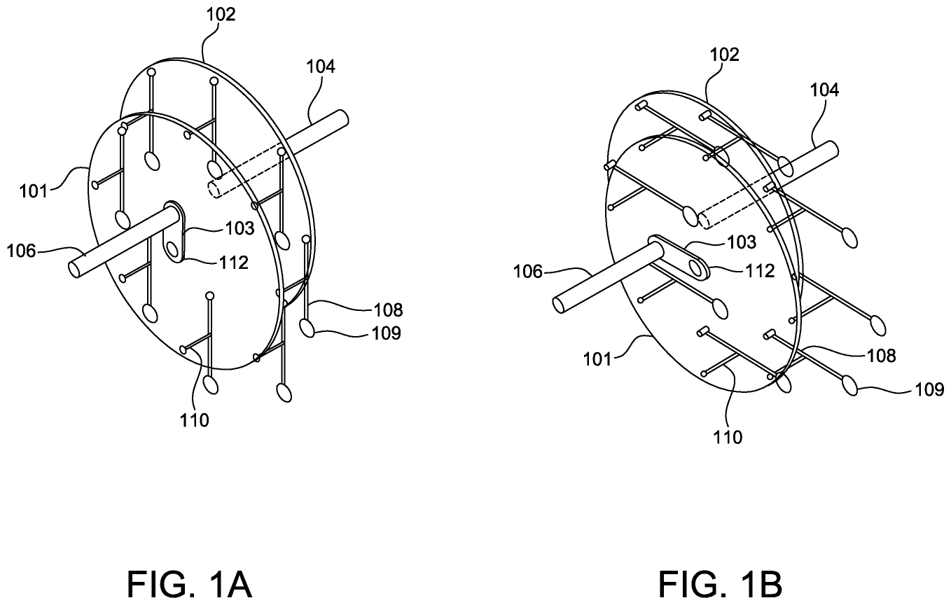

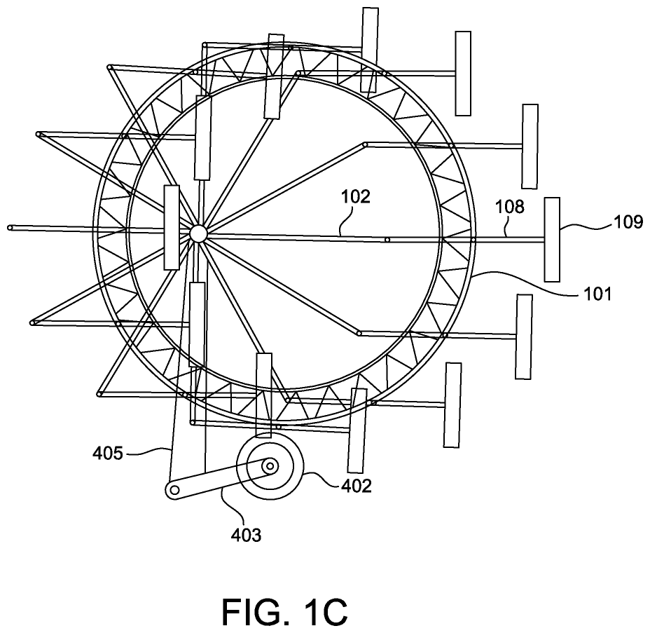

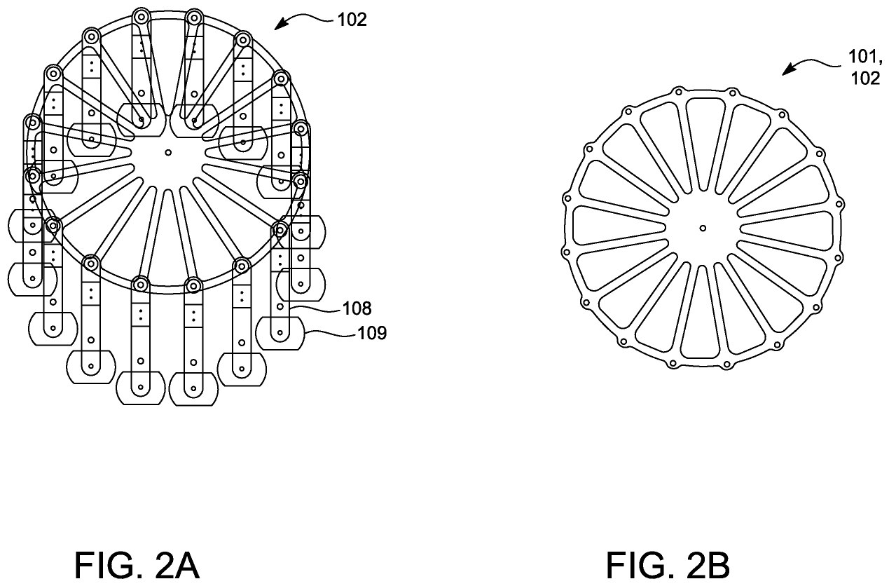

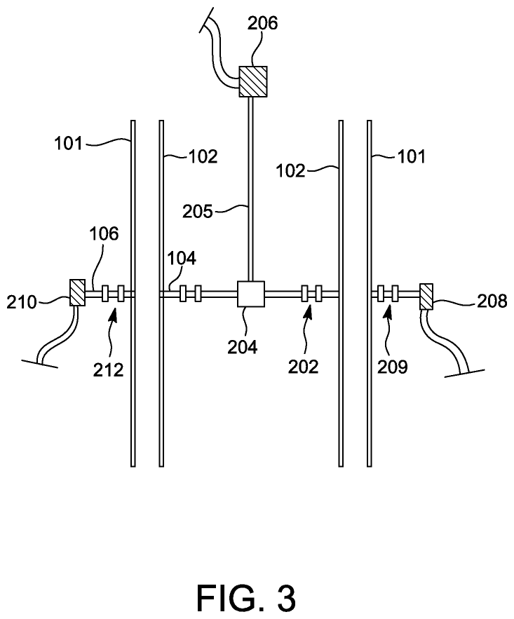

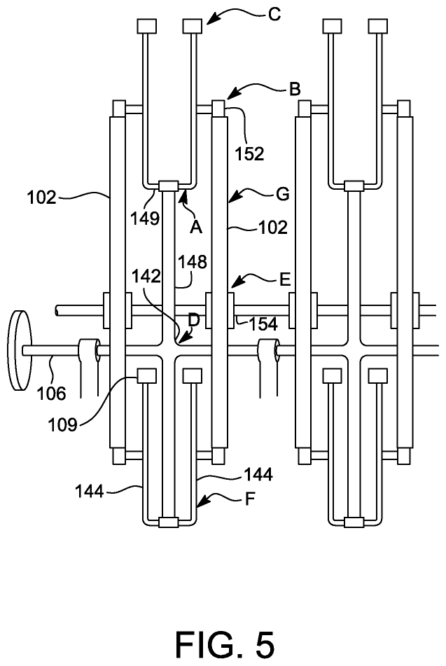

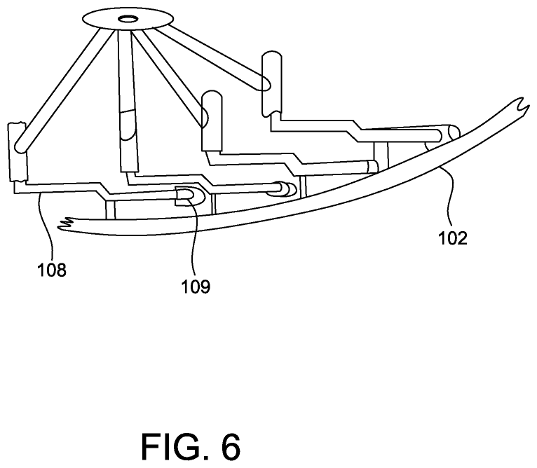

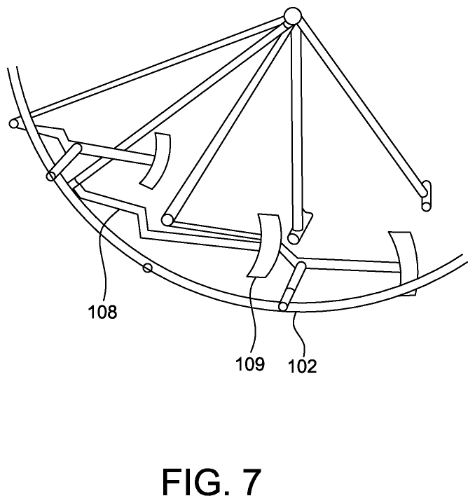

Referring to FIGS. 1A, 1B and 2a and 2B there is a drive wheel (or ring) also termed main wheel, 102, connected in the center by shaft 104 and a control wheel (ring) 101 connected in the center by connector 112. Connector 112 is, in one embodiment, connected toan offset structure 103 that is, in turn, connected to shaft 106. Wheels 101 and 102 are connected together by control links 110, that connect to the weighted hinged arms 108 on which are disposed weights 104. The drawings show the hinged weighted arms as a single straight structure; however, it is necessary that the arms be offset as more fully illustrated in 108 of FIGS. 6 and 7. The arms may be doubled as shown in FIG. 5. Otherwise, the arms when moving will hang up on the adjacent arm. The length of section of 108 in FIGS. 6 and 7 that connect to the structure (as opposed to the weights) will be determined by the spacing of the hinged arms 108 on the wheel structure so that the section attached to the weights will pass the adjacent arm on the structure when the wheel 102 rotates. The weighted hinged armsare illustrated in FIGS. 1C and 2A and have weights disposed on the ends away from the wheel. Hinged as used herein and in the claims means reference to arms and pivotable connectors that allow the arm to swivel.

As shown in FIGS. 1A, 1B and 2A and 2B the wheel has a rim on the outer edge of the wheel (ring). The hinged arms attached to this rim as clearly illustrated in FIG. 2A. The rim may simply be the edge of the wheel or a reinforced section of the edge. As a preferred alternative to the structure illustrated in FIGS. 1A and 1B, FIG. 1C illustrates another embodiment. In FIG. 1C (that shows two machines connected in tandem), there is a main frame 142, to which is connected arms 144 and 145 on an extension, 148, of the main frame 142. In this embodiment there no rim on the main frame; the arms are connected directly to the ends of the arms. The arms are connected to a central hub that is also connected to the shaft 104. By hinged, in reference to the weighted arms, is meant that they are attached, preferable by bearings, by a connector that allows them to move or swivel so they will rotate up or down as depending on the position of the wheel.

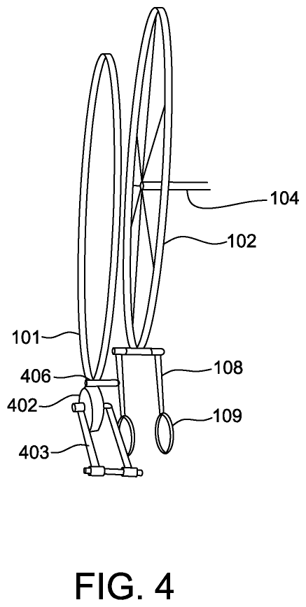

The wheel 101 may also be disposed on a shift wheel assembly 112/103 as shown in FIG. 10 and FIG. 4 as shown in the assembly of 402, 403, 405 406. FIG. 10 also shows the support wheel assembly. The control ring or wheel 101 rests on the small wheel 402 that is connected to arm 403, that in turn, connected to structure 405. As the wheel moves to the right, as explained below, the wheel assembly will be in the position shown in FIG. 1A. When the wheel 101 is shifted to the left the small support wheel 404 assembly will be vertical. [0017] The wheels may be solid, that is, like a single sheet of material, or may have spokes as illustrated in FIG. 2. Wheel 102 may be arms extending from a single hub. Wheels with spokes are preferred as they have less weight. In FIG. 2 wheel 102 is shown with weight 109 on the hinged weight arms, 108.

FIG. 2 illustrates two machines in tandem, interconnected by a differential structure,

204. This assembly comprises two machine wheel assemblies as illustrated in FIG. 1, connected in an array to enhance rotational power output. The rotation of shafts 106 and the companion shaft on the other machine are connected to a differential, 204, that transmit the rotational energy of the rotating a shaft 104 to a torque translator 206, 208 and 210 that can be connected to an end use device such as a generator, motor, or any other similar device driven by rotating means. 202, 209 and 212 are bearings.

As discussed above the hinged weight arms will preferably have two legs as illustrated in FIG. 5. The legs are offset as shown to prevent contact when they are rotating. It is preferable that each drive wheel (102) have at least 8, but as many as 32, hinged arms. About 16 arms work well.

In operation, as illustrated in FIG. 1A, the hinged weight arms on wheel 102 are hanging down when machine is at rest. When wheel 101 is shifted to the right as shown in FIG. 1B the hinged weight arms are extended. The weight on the arms will cause, by the force of gravity, the arms to fall and thus rotate the wheel 102 clockwise. Through the shown connections, as 110, this rotation will cause wheel 101 to be shifted back to the position shown in FIG. 1A, raising the arms on wheel 102 to the position shown in 1B, to begin the rotational cycle again. The shaft 104 will rotate, and can be configured with suitable apparatus, to harvest the rotational energy include generators and motors and similar equipment that operate by rotational power.

Operation of the embodiment shown in FIG. 10, and FIG. 5 is as follows. Referring to FIG. 5, 142 is the main frame (wheel assembly). It carries the arms 108 that pivot, 152, on the end of each arm. It is connected to the main shaft 106 that is the machine power output. The pivot points, 149, of the arms carry the weights that connect the arms 108 to the main frame.

Pivot points 152 on the control ring (102) shift the weights, 109, 90° from hanging straight down to full horizontal position on the side of the main frame. The weights can be made of any suitable material, such as steel, iron, and metal that holds its shape under weight, engineered polymer and the like. The wheel 152 lifts the structure in order to raise the weight to a horizontal position, as illustrated in FIG. 1A. This causes the main frame to be unbalanced. As the weights are shifted to one side the main frame become unbalanced and starts to turn. As more of the mass of the weights shift to one side leverage will increase causing the main frame to overcome resistance in the bearing and letting the whole frame turn, thus turning the main shaft.

Although the Invention hereof has been described by way of preferred embodiments, it will be evident that other adaptations and modifications can be employed without departing from the spirit and scope thereof. The terms and expressions employed herein have been used as terms of description and not of limitation; and thus, there is no intent of excluding equivalents, but on the contrary, it is intended to cover any and all equivalents that may be employed without departing from the spirit and scope of the invention.

Embodiments of the present invention have been described, as required by statute, to be illustrative, but should not be interpreted to be restrictive. One having skill in the art will recognize that many different arrangements of the various components depicted are possible without departing from the scope of the claims below, as well as arrangements including components not explicitly shown.

One having skill in the art will understand that certain combinations and/or sub-combinations of elements and features are of utility and may be employed without reference to other combinations and/or sub-combinations and are contemplated within the scope of the claims. Not all steps listed in the various figures need be carried out in the specific order described.

What is claimed is:

1. A machine in comprising:
a first wheel having a weighted hinged arms; and
a second wheel that is horizontally moveable,
the second wheel having a rim,
wherein the first wheel and the second wheel are connected together by a set of connectors extending from the weighted hinged arms of the first wheel to the rim of the second wheel,
wherein the second wheel is configured to move from a first position to a second position when the first wheel rotates.

2. The machine of claim 1 wherein both the first wheel and the second wheel have spokes.

3. The machine of claim 1 wherein the first wheel and the second wheel are connected to a shaft that rotates with the first wheel.

4. The machine of claim 3 wherein the shaft is connected to a machine operated by a rotating shaft.

5. The machine of claim 4 wherein the machine operated by rotating shaft is an electric generator or a motor.
